(19) United States
(12) Patent Application Publication
(10) Pub. No.: US 2013/0141417 A1
(43) Pub. Date: Jun. 6, 2013

(54) Drive Circuit, LCD Panel Module, LCD Device, and Driving Method

(71) Applicant: Chenghung Chen, Shenzhen (CN)

(72) Inventor: Chenghung Chen, Shenzhen (CN)

(21) Appl. No.: 13/378,766

(22) PCT Filed: Dec. 7, 2011
(86) PCT No.: PCT/CN11/83630

§ 371 Date: Dec. 16, 2011

(30) Foreign Application Priority Data
Dec. 2, 2011 (CN) 201110396112X

(51) Int. Cl. G09G 3/36; G09G 5/00

(52) U.S. Cl. 345/215; 345/92; 345/204

(57) ABSTRACT

The invention discloses a drive circuit, an LCD panel module, an LCD device, and a driving method. A drive circuit for an LCD device, includes: scan line(s), data line(s), common line(s), and a pixel TFT; a source electrode of the pixel TFT is connected with the data line, a gate electrode of the pixel TFT is connected with the scan line, and a controllable switch is connected between a drain electrode of the pixel TFT and the common line. The invention can reduce the scanning time and improve the charging rate of the pixel electrode.

### TECHNICAL FIELD

The invention relates to the field of liquid crystal displays (LCDs), and more particularly to a drive circuit, an LCD panel module, an LCD device, and a driving method.

### BACKGROUND

An LCD device includes an LCD drive circuit. FIG. 1 is an equivalent drive circuit diagram of a single pixel of an existing thin film transistor (TFT) LCD, wherein G(n-1) and G(n) respectively represent a former scan line and a current scan line; Com represents a common line on the TFT side. T represents the abbreviation of a TFT. CF_Com represents a common electrode on the color filter (CF) side. C_{ST} and C_{LC} respectively represent a storage capacitor and a liquid crystal (LC) capacitor. FIG. 2 shows a drive waveform corresponding to FIG. 1. In general, to avoid image deteriorate, or image sticking and the like, a bipolar driving mode is employed on time. That is to say, if the data potential of one frame is higher than the common potential (positive polarity), the potential of the next frame is lower than the common potential (negative polarity). However, because the difference between the potential of the positive polarity and the potential of the negative polarity is often large, if a capacitor fully charged with one polarity is to be charged to the other polarity, a TFT with large current is required or the charging time of a pixel is required to be prolonged. If the pixel charging time is prolonged, the scanning frequency will decrease, thereby influencing the image display quality; if the ON current of the TFT is added, the design and manufacture difficulty of the TFT is increased, and so is the cost.

### SUMMARY

The aim of the invention is to provide a drive circuit, an LCD panel module, an LCD device, and a driving method capable of improving pixel charging rate and reducing pixel charging time.

The purpose of the invention is achieved by the following technical schemes.

A drive circuit for LCD device, comprises: scan line(s), data line(s), common line(s), and pixel TFT(s); a source electrode of the pixel TFT is connected with the data line, a gate electrode of the pixel TFT is connected with the scan line, and a controllable switch is connected between a drain electrode of the pixel TFT and the common line.

Preferably, a control end of the controllable switch is connected with a former scan line of a scan line connected with the pixel TFT. To ensure the image display quality of the current frame, the electric quantity of a storage capacitor needs to be kept to the next scanning period. Therefore, to reduce the pixel charging time, improve the charging rate, and guarantee the image quality as possibly, it is practicable to precharge the liquid crystal capacitor by turning on the controllable switch in advance of a scanning interval. The scan line connected with the pixel TFT is just separated from its former scan line at one scanning interval. Thus, using the former scan line to control the controllable switch can simplify the circuit design and the control mode, and reduce the cost.

Preferably, the controllable switch comprises a precharge TFT; a source electrode or drain electrode of the precharge TFT is connected with the drain electrode of the pixel TFT; a drain electrode or source electrode of the precharge TFT is connected with the common line; a gate electrode of the precharge TFT is connected with a former scan line of a scan line connected with the pixel TFT. This is a specific form of the controllable switch. The TFT used as the controllable switch can be formed when the pixel TFT is manufactured, without adding additional manufacturing process, thereby improving the productivity and reducing the cost.

An LCD panel module comprises the drive circuit for an LCD device.

An LCD device comprises the LCD panel module.

A driving method for an LCD device, comprises enabling the potential of a drain electrode of a pixel TFT to be consistent with the potential of a common line by a controllable switch before driving the pixel TFT.

Preferably, the controllable switch is turned on in advance of a scanning interval before the pixel TFT is turned on, and is kept until the pixel TFT is turned on. To ensure the image display quality of the current frame, the electric quantity of the storage capacitor needs to be kept to the next scanning period. Therefore, to reduce the pixel charging time, improve the charging rate, and guarantee the image quality as possibly, it is practicable to precharge the liquid crystal capacitor by turning on the controllable switch in advance of a scanning interval.

Preferably, the controllable switch comprises a precharge TFT; a source electrode or drain electrode of the precharge TFT is connected with the drain electrode of the pixel TFT; a drain electrode or source electrode of the precharge TFT is connected with the common line; a gate electrode of the precharge TFT is connected with a former scan line of a scan line connected with the pixel TFT. This is a specific form of the controllable switch. The TFT used as the controllable switch can be formed when the pixel TFT is manufactured, without adding additional manufacturing process, thereby improving the productivity and reducing the cost.

In the invention, because both ends of the storage capacitor are in parallel connection with a controllable switch, the pixel electrode can be charged to the potential of the common line between the potential of the positive polarity and the potential of the negative polarity prior to the turn on of the pixel TFT. Thus, when the pixel TFT is turned on, electricity can be directly complemented to a predetermined potential on the basis of the potential of the common line. Therefore, the scanning time is reduced, and the pixel electrode charging rate is improved. Furthermore, when the pixel TFT is turned on, the pressure difference between the source electrode and the drain electrode of the pixel TFT is the pressure difference between the current data line and the common line. Compared to the pressure difference between the existing data line and its counter electrode, the pressure difference between the source electrode and the drain electrode of the pixel TFT of the invention when the pixel TFT is turned is obviously reduced, the risk of high-voltage flashover of the pixel TFT is reduced, and the service life of the pixel TFT is improved.

### BRIEF DESCRIPTION OF FIGURES

FIG. 1 is an equivalent drive circuit diagram of a single pixel of an existing TFT LCD;

FIG. 2 is a waveform diagram corresponding to FIG. 1;

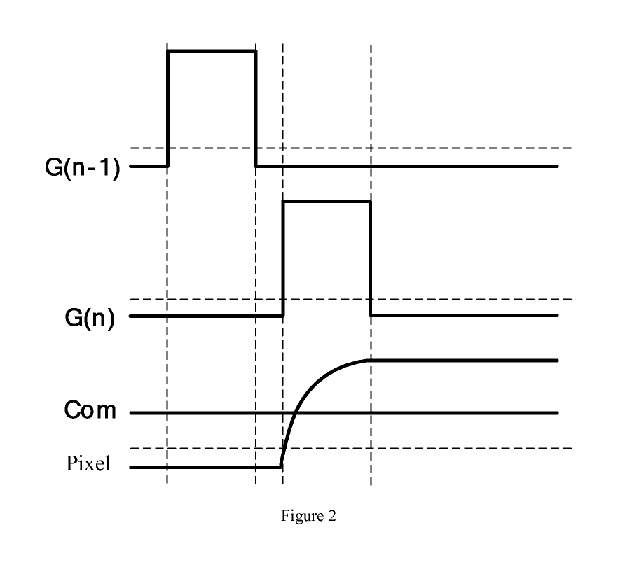

FIG. 3 is a schematic diagram of a drive circuit for an LCD device of the invention; and

FIG. 4 is a waveform diagram of a drive circuit for an LCD device of the invention.

### DETAILED DESCRIPTION

The invention will further be described in detail in accordance with the figures and the preferred examples.

An LCD device comprises an LCD panel module; the LCD panel module comprises an LCD panel and a drive circuit; the drive circuit comprises scan line(s), data line(s), common line(s), and a pixel TFT T1; a source electrode of the pixel TFT T1 is connected with one data line, a gate electrode of the pixel TFT is connected with one scan line, a liquid crystal capacitor C_{LC} is connected between a drain electrode of the pixel TFT T1 and the common line, and a storage capacitor C_{ST} is connected between the drain electrode of the pixel TFT T1 and the common line; and a controllable switch in parallel connection with the storage capacitor C_{ST} is connected between the drain electrode of the pixel TFT T1 and the common line.

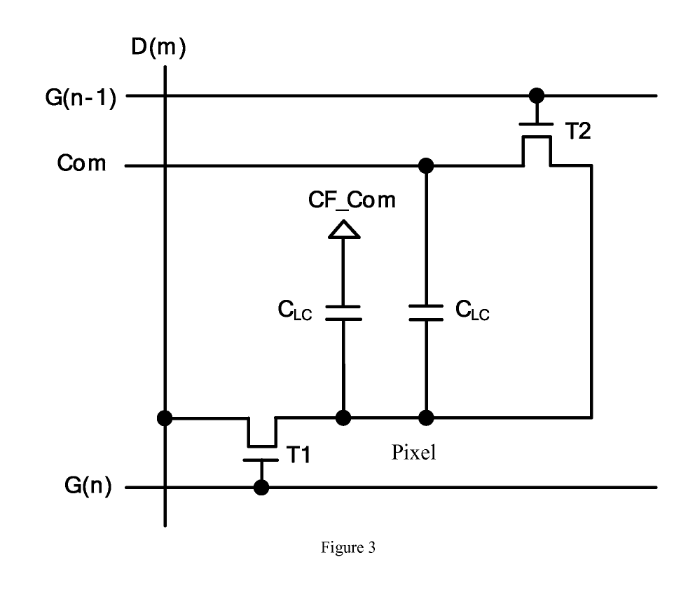

As shown in FIG. 3, the controllable switch comprises a precharge TFT T2; a source electrode or drain electrode of the precharge TFT T2 is connected with the drain electrode of the pixel TFT T1; a drain electrode or source electrode of the precharge TFT T2 is connected with the common line; a gate electrode of the precharge TFT T2 is connected with a former scan line of a scan line connected with the pixel TFT T1. This is a specific form of the controllable switch. The TFT used as the controllable switch can be formed when pixel TFT T1 is manufactured, without adding additional manufacturing process, thereby improving the productivity and reducing the cost.

Optionally, the controllable switch can be other controllable switches such as MOSFET, triode and the like; the control end of the controllable switch is not limited to the mode of being connected to the former scan line, all the other modes should be considered to fall into the protection scope of the invention as long as the ON of the controllable switch can be controlled before the pixel TFT T1 is turned on, and the OFF of the controllable switch can be controlled when the pixel TFT T1 is turned on.

The aforementioned LCD device driving method, comprises enabling the potential of the drain electrode of the pixel TFT T1 to be consistent with the potential of the common line by short-circuiting both ends of the storage capacitor CST using the controllable switch before driving the pixel TFT T1.

The controllable switch is turned on in advance of a scanning interval before the pixel TFT T1 is turned on, and kept until the pixel TFT T1 is turned on. To ensure the image display quality of the current frame, the electric quantity of a storage capacitor needs to be kept to the next scanning period. Therefore, to reduce the pixel charging time, improve the charging rate, and guarantee the image quality as possibly, it is practicable to precharge the liquid crystal capacitor C_{LC} by turning on the controllable switch in advance of a scanning interval.

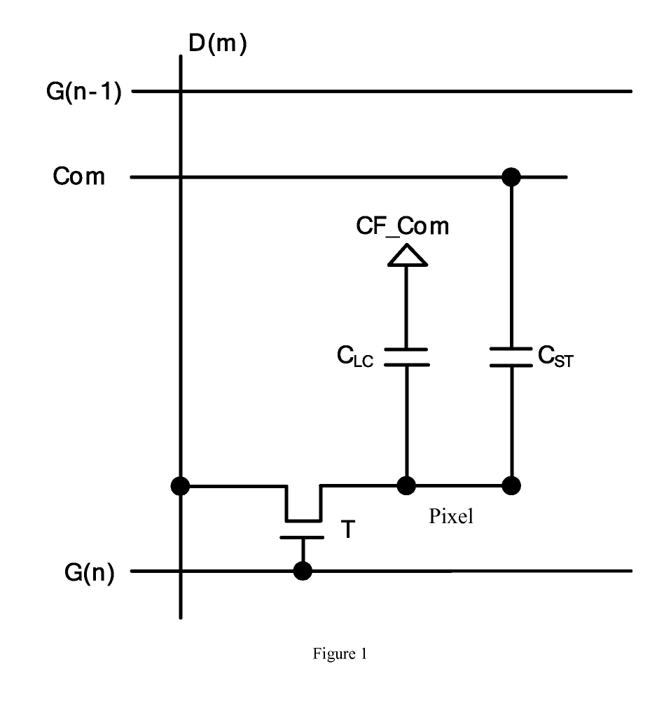

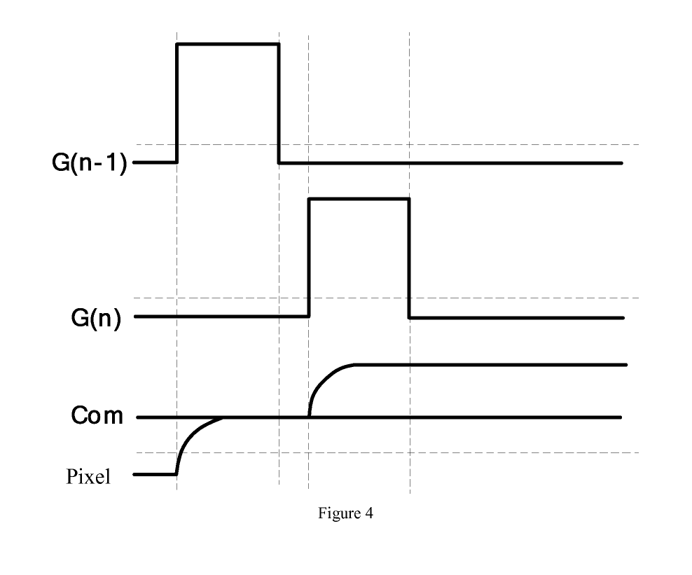

In the example, an additional TFT (precharge TFT T2) is added into the equivalent circuit diagram (see FIG. 1) of a traditional pixel, the gate electrode of the TFT is connected to the former scan line G(n-1) before the current scan line G(n) corresponding to the pixel electrode; the source electrode and the drain electrode are respectively connected to the common line (com) and the pixel electrode (pixel) of the array substrate. FIG. 4 is a corresponding drive waveform diagram. When the pixel capacitor is precharged to the positive potential of the next frame from the negative potential of the former frame, the pixel electrode is charged to the Com potential between the potential of the positive polarity and the potential of the negative polarity when the former scan line G(n-1) is turned. Thus, the ON time of the later scan line G(n) is shortened, and the charging rate increased.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A drive circuit for LCD device, comprising: scan line(s), data line(s), common line(s), and a pixel TFT; wherein a source electrode of said pixel TFT is connected with said data line, a gate electrode of said pixel TFT is connected with the scan line, and a controllable switch is connected between a drain electrode of said pixel TFT and said common line.

2. The drive circuit for LCD device of claim 1, wherein a control end of said controllable switch is connected with a former scan line of a scan line connected with said pixel TFT.

3. The drive circuit for LCD device of claim 1, wherein said controllable switch comprises a precharge TFT; a source electrode or drain electrode of said precharge TFT is connected with the drain electrode of said pixel TFT; a drain electrode or source electrode of said precharge TFT is connected with said common line; and a gate electrode of said precharge TFT is connected with a former scan line of a scan line connected with said pixel TFT.

4. An LCD panel module, comprising: the drive circuit for LCD device of claim 1; wherein said drive circuit comprises scan line(s), data line(s), common line(s), and a pixel TFT; a source electrode of the pixel TFT is connected with the data line, a gate electrode of the pixel TFT is connected with the scan line, and a controllable switch is connected between a drain electrode of said pixel TFT and said common line.

5. The LCD panel module of claim 4, wherein a control end of said controllable switch is connected with a former scan line of a scan line connected with said pixel TFT.

6. The LCD panel module of claim 4, wherein said controllable switch comprises a precharge TFT; a source electrode or drain electrode of said precharge TFT is connected with the drain electrode of said pixel TFT; a drain electrode or source electrode of said precharge TFT is connected with said common line; and a gate electrode of said precharge TFT is connected with a former scan line of a scan line connected with said pixel TFT.

7. An LCD device, comprising an LCD panel module; wherein the LCD panel module comprises a drive circuit for the LCD device of claim 1, the drive circuit comprises scan line(s), data line(s), common line(s), and a pixel TFT; a source electrode of said pixel TFT is connected with said data line, a gate electrode of said pixel TFT is connected with the scan line, and a controllable switch is connected between a drain electrode of said pixel TFT and said common line.

8. The LCD panel module of claim 7, wherein a control end of said controllable switch is connected with a former scan line of a scan line connected with said pixel TFT.

9. The LCD panel module of claim 7, wherein said controllable switch comprises a precharge TFT; a source electrode or drain electrode of said precharge TFT is connected with the drain electrode of said pixel TFT; a drain electrode or source electrode of said precharge TFT is connected with said common line; and a gate electrode of said precharge TFT is connected with a former scan line of a scan line connected with said pixel TFT.

10. A driving method for an LCD device, comprising: enabling the potential of a drain electrode of a pixel TFT to be consistent with the potential of a common line by a controllable switch before driving the pixel TFT.

11. The LCD device driving method of claim 10, wherein said controllable switch is turned on in advance of a scanning interval before the pixel TFT is turned on, and is kept until the pixel TFT is turned on.

12. The LCD device driving method of claim 10, wherein said controllable switch comprises a precharge TFT; a source electrode or drain electrode of said precharge TFT is connected with the drain electrode of said pixel TFT; a drain electrode or source electrode of said precharge TFT is connected with said common line; and a gate electrode of said precharge TFT is connected with a former scan line of a scan line connected with said pixel TFT.
